(19) United States
(12) Patent Application Publication
(10) Pub. No.: US 2016/0294176 A1
(43) Pub. Date: Oct. 6, 2016

(54) Formable Cable Sleeve

(71) Applicant: Gururaj Krishnan, Holmdel, NJ (US)

(72) Inventor: Gururaj Krishnan, Holmdel, NJ (US)

(21) Appl. No.: 14/677,243

(22) Filed: Apr. 2, 2015

(51) Int. Cl. H02G 15/18; H02G 3/08

(52) U.S. Cl. CPC H02G 15/18; H02G 3/08

(57) ABSTRACT

A shape-holding sleeve that can retain an electrical cable, thereby allowing the cable to conform to an exact path between two points.

### FIELD OF THE INVENTION

The present invention relates to cable organizers, and in particular, a formable, shape-holding cable sleeve that can be used in connection with a cable to enable the cable to conform to a user-determined path between two points.

### BACKGROUND OF THE INVENTION

Extant sleeves that are applied on cables, including but not limited to, electrical cables and cords, data cables, speaker wire, audio and/or video connections and the like, all referred to herein as “cables,” are typically for providing abrasion-resistance, organization or for the aggregation/bundling of multiple cables. However, such sleeves lack any shape-holding properties and often require much time and effort to install. On the other hand, there have been various proposals for shape-holding electrical cables, such as for example in U.S. Published Patent Application Nos. 2014/330632 and 2013/0306372. However, these shape-holding cables lack the ability to be aggregated/bundled with multiple cables and further require the cable manufacturer to incur the added expense of adding shape-holding properties to the cable. Because of this, not all manufacturers will undertake to make their cables shape-retaining, and therefore such shape-holding cables, when in use with non-shape-holding cables, provides an incomplete solution to cable organization.

The prior art does not disclose an easy way to organize and store cables in a desirable, effortless fashion. Access to some cables, such as a charging cable for a mobile device, is needed on a daily basis, so the organization has to be in sight, presentable and readily accessible. Accordingly, there is a need in the art for a formable cable sleeve that is aesthetically pleasing, can be easily aggregated or bundled with other cables, and can be used in connection with most sizes and shapes of electrical cables.

This invention makes known a cable sleeve that contains one or more shape-holding members that can be placed over extant cables to hold their shape. The cable sleeve can be applied over one or multiple cables and enables the cables to be run through an exact path and supporting all turns of the cables, including 90 degree turns and U-turns. It should be understood that the cable sleeve described herein is not limited to use with cables and may also be adapted for use with ropes, hoses and other elongated objected that are non-shape-holding.

### SUMMARY OF THE INVENTION

The present invention has been devised to more conveniently, safely and effortlessly organize one or more cables. The cable sleeve of the present invention allows cables to be placed in an exact position, which the sleeve will retain, and run flush along walls, floors and furniture without the need for any additional securing, as well as support multiple changes in directions such as right-angle turns, U-turns and coils. The cable sleeve of the present invention also enables a cable to be folded for compact storage and carrying ability.

The present invention is directed generally to a cable sleeve having a flexible conduit having a first end with an opening and a second end with an opening, and a shape-holding member that extends along at least a portion of the flexible conduit. In a preferred embodiment, the shape-holding member extends substantially from the first end to the second end of the flexible conduit. The flexible conduit also preferably has a slot that extends substantially from the first end to the second end of the flexible conduit. The slot permits a cable to be introduced to an internal cavity of the flexible conduit, and preferably touches or overlaps at its edges to keep the flexible conduit in a closed configuration. Alternatively, a cable may be fed through the opening at the first end or second end without the need for a slot.

One or more shape-holding members reinforce the flexible conduit and may be maintained in a separate pocket on the flexible conduit, affixed to the flexible conduit by adhesive, woven into the flexible conduit or disposed integrally into the wall of the flexible conduit. The shape-holding members impart the flexible conduit with shape-holding properties. Thus, the cable sleeve of the present invention can conform to almost any user-defined path between two points.

In an aspect of the invention, the cable sleeve may employ loops that can be used to hang the cable sleeve on one or more hooks secured against a wall or a supporting object thereby providing a tidy self-supported cable run. In another aspect of the invention, the cable sleeve may employ openings with reinforced edges at various points along its length that can be used to hang the cable sleeve on one or more hooks secured against a wall or a supporting object thereby providing a tidy self-supported cable run.

In another aspect of the invention, a routing plate employing a flat substrate allows multiple cable sleeves of the present invention to be crisscrossed or run over one another without tangling. The planar sides of the substrate are equipped with hooks, loops or pathways for receiving a cable sleeve. Thus, in use, cable sleeves running a certain direction can be affixed to one planar side of the routing structure, while sleeves running in a substantially perpendicular direction can be affixed to the opposite planar side of the routing structure.

In another embodiment, a junction box defining an enclosed structure has channels or notches in both parallel and crisscrossing directions that provide room for the cable sleeves to pass through. The top of the junction box may be detachable so that cable sleeves may be placed in a desired position and the top reattached. The routing plate or junction box may be fastened to a wall, floor, ceiling or other surface or allowed to hang freely.

In an aspect of the invention, a free-standing support is available to hang cable sleeves at any point as desired. The free-standing support is constructed of a relatively heavy block, similar to a paperweight, employing one or more hooks, loops or clamps. The free-standing support can be placed on any horizontal surface and a sleeve can be hung from the free-standing support by the loops or reinforced openings described above.

### BRIEF DESCRIPTION OF THE DRAWINGS

FIG. 1 is a perspective view of an embodiment of the cable sleeve of the present invention in use along the baseboard of a wall.

FIG. 2 is a perspective view of an embodiment of the cable sleeve of the present invention.

FIG. 3 is a perspective view of another embodiment of the cable sleeve of the present invention.

FIG. 4 is a front view of an embodiment of the cable sleeve of the present invention.

FIG. 5 is a front view of another embodiment of the cable sleeve of the present invention.

FIG. 6 is an exploded view of the junction box of the present invention in use with a cable sleeve of the present invention.

FIG. 7 is a perspective view of the routing plate of the present invention.

### DETAILED DESCRIPTION

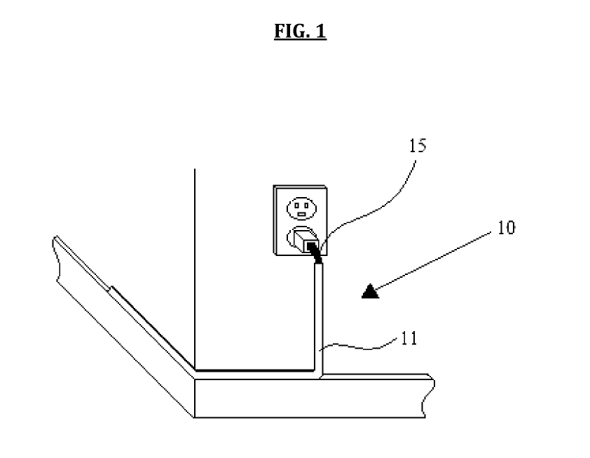

Referring to FIGS. 1 through 5, a preferred embodiment of the present cable sleeve 10 is illustrated. FIG. 1 illustrates a cable sleeve 10 of the present invention in use along the baseboard of a wall.

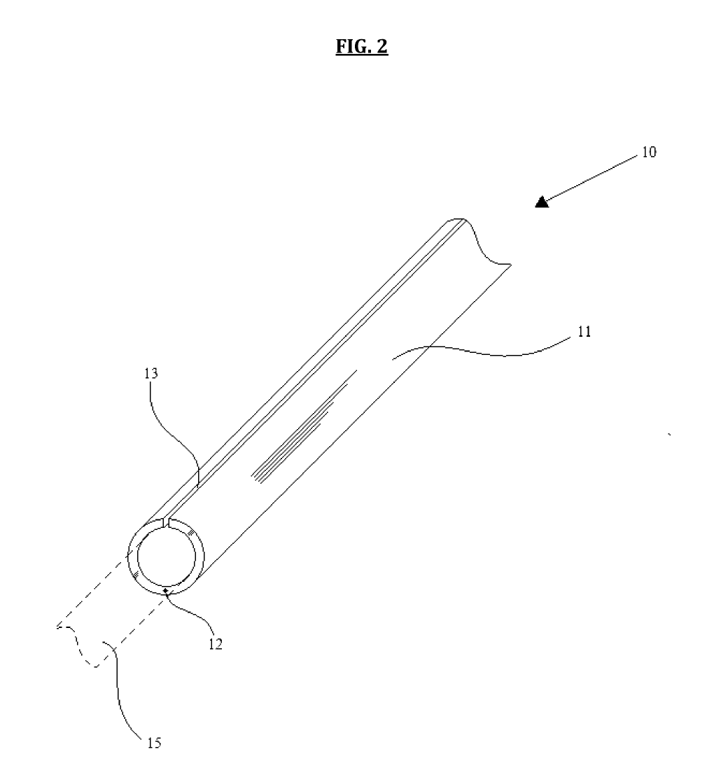

FIG. 2 illustrates a perspective view of a cable sleeve 10 in accordance with an embodiment of the present invention. The cable sleeve 10, employing a flexible conduit 11 and a shape-holding member 12, may be placed around a cable 15 by placing the cable 15 through an elongated slot 13 in the flexible conduit 11 that provides access from the outer surface of the flexible conduit 11 to the interior cavity of the flexible conduit 11. The cable sleeve 10 is removable, and may be attached to one or more cables 15 and subsequently detached. The cable 15 may then be connected to a power outlet, electronic device, wall jack or the like and positioned along a wall, floor or work surface as desired.

After one or more cables are placed in the internal cavity of the cable sleeve 10 via the slot 13, the cable sleeve 10 can be secured over the cable 15 through a number of mechanisms, including an elastic memory that brings the edges of the slot 13 into touching or overlapping relationship or separate members such as fasteners including zippers, buttons, snaps, tape, hooks, magnets, hook and loop fasteners and combinations thereof. In an embodiment using fasteners, the fasteners run along the edges of the slot 13 and enable the slot 13 to be transitioned from an open position to a locked position so that the cable 15 within the cable sleeve 10 is tightly secured and will not slip out. In an embodiment wherein the flexible conduit 11 is composed of a resilient material, if a cable 15 is pressed against the slot 13 or if the flexible conduit 11 is pinched by a user, the slot 13 will deflect from a closed position to an open position to allow a cable 15 to be placed within the cable sleeve 10 and the slot 13 will return to a closed position thereafter.

In embodiments of the present invention, the flexible conduit 11 and shape-holding member 12 are made from materials that easily can be cut so that the cable sleeve 10 can be cut to size. This allows the cable sleeve 10 to be cut by a user to accommodate various cable 15 lengths. Moreover, the cable sleeve 10 can be cut into small segments and used to surround only those portions of a cable 15 where bending, such as 90-degree turns and U-turns, is required while still providing directional guiding of the cable 15.

The flexible conduit 11 is preferably made from a material with resilient properties and that is capable of being bent to any angle from 5-355°, preferably 0-360°. Suitable materials for the flexible conduit 11 are rubber, polyurethane, polyethylene, polystyrene, neoprene, thermoplastic elastomers, natural fabrics, synthetic fabrics, metal-mesh and nylon.

In some embodiments, the flexible conduit 11 may be thought of as a tube with an overall cross-section in the shape of a circle, rectangle, square, triangle or other polygon. In an alternative embodiment, the flexible conduit 11 may be a flexible substrate, on which one or more cables 15 are placed, and the flexible substrate is then wrapped around the one or more cables 15 and fastened by magnets, snaps, buttons, hook and loop fasteners, tape, adhesive, clips or combinations thereof that are located along one or both of the lateral edges of the substrate thereby forming an enclosed sleeve. In such an embodiment, the need for a slot 13 is alleviated.

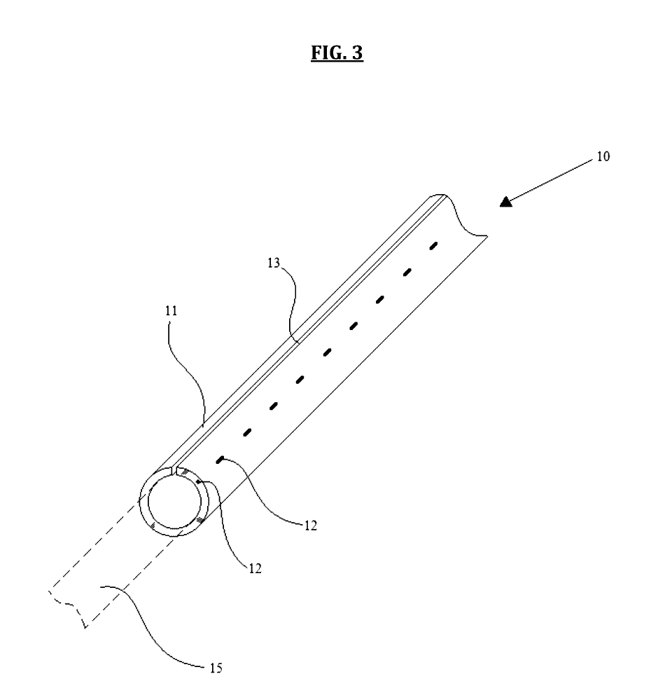

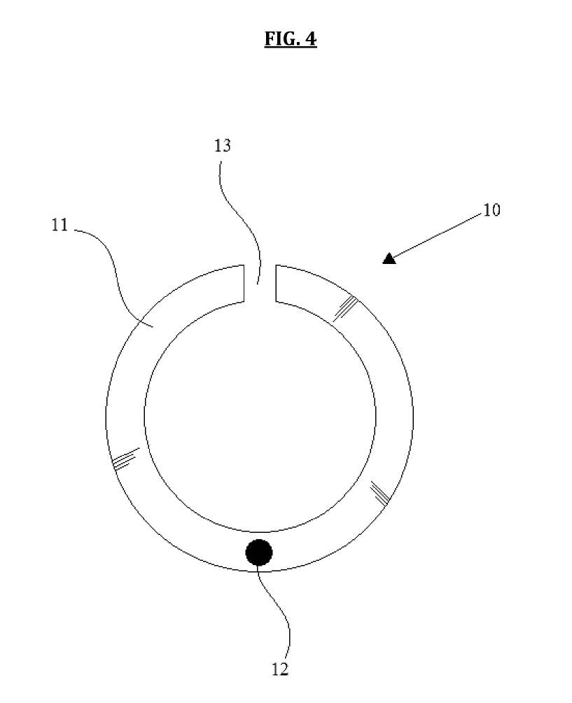

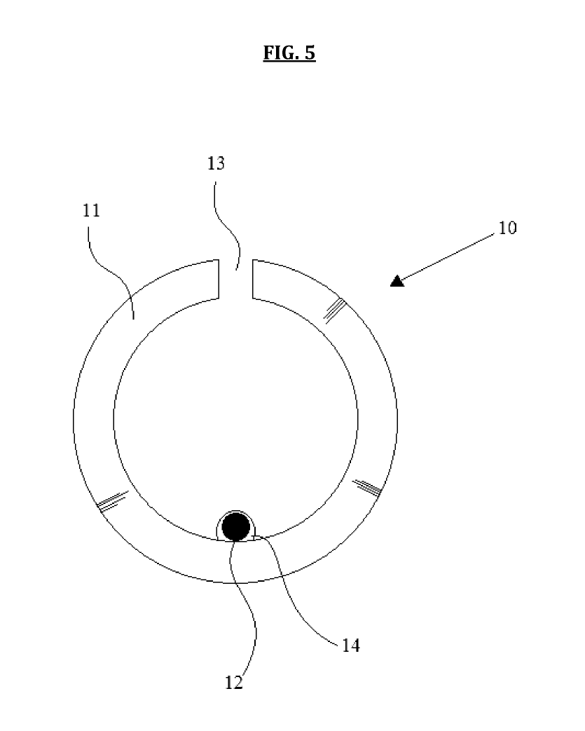

FIG. 5 illustrates the construction of the cable sleeve 10 with a flexible conduit 11 that employs one or more pockets 14 running laterally along the flexible conduit 11. One or more shape-holding members 12 are inserted in the pocket 14 to impart shape-holding properties to the flexible conduit 11. In another embodiment, the shape-holding member 12 may be affixed directly to the inner or outer surface of the flexible conduit 11 preferably by an adhesive. In a further embodiment, as illustrated in FIG. 3, the shape-holding member 12 may be woven into the flexible conduit 11, which is suitable for a flexible conduit 11 made from a fabric, metal-mesh or nylon. In an additional embodiment, as illustrated in FIG. 4, the shape-holding member 12 may be disposed in the wall of the flexible conduit 11, which is most suitable for a flexible conduit 11 made from rubber, polyurethane, polyethylene, polystyrene, neoprene or thermoplastic elastomers.

The terminal ends of shape-holding member 12 may be bent to provide smooth rounded ends and prevent the shape-holding member 12 from damaging the flexible conduit 11 or any cables placed therein. In another embodiment, the ends of the shape-holding member 12 may employ an end cap, much like the pinhead of a pin, to provide smooth ends and prevent damage.

The flexible conduit 11 has an outer surface and an interior cavity defined by the inner surface of the flexible conduit 11 that is suitable for retaining a cable 15 therein. In embodiments employing one or more pockets 14, the pocket 14 may be positioned at the inner surface or outer surface of the flexible conduit 11. In embodiments wherein the shape-holding member 12 is affixed directly to the flexible conduit 11, it may affixed at the inner surface or outer surface. In embodiments wherein the shape-holding member 12 is disposed within the wall of the flexible conduit 11, the shape-holding member 12 may be disposed in the space defined between the outer surface and inner surface of the flexible conduit 11. Of course, one or more of the shape-holding members 12 can be used with a length of flexible conduit 11, including various combinations of incorporating the shape-holding member 12 on the flexible conduit 11 as discussed above, and otherwise.

In an embodiment of the present invention, the flexible conduit 11 has a cross-sectional diameter of from about 0.125 inches to about 1 inch, preferably about 0.25 inches to about 0.75 inches and most preferably about 0.5 inches. The flexible conduit 11 has a length that is at least about 2 times its cross-sectional diameter, preferably about 3 times to about 96 times, more preferably about 4 times to about 60 times, and most preferably about 6 times to about 48 times. In a preferred embodiment, the flexible conduit 11 has a length of about 3 feet, 4 feet, 5 feet or 6 feet. The internal cavity of the flexible conduit 11 has a cross-sectional internal diameter of from about 0.125 inches to about 1 inch, preferably about 0.25 inches to about 0.75 inches and most preferably about 0.5 inches.

The shape-holding member 12 may be made from any suitable formable and shape-holding metal or metal alloy, preferably, copper, steel, aluminum or tin. The term shape-holding is taken to mean pliable and yet rigid in maintaining a shape of the flexible conduit 11 incorporating the shape-holding member 12 once bent to conform to said shape. The shape-holding member imparts malleable, pliable and bendable properties to the cable sleeve 10. Thus, the instant cable sleeve 10 may remain in a position in which a user places it and may resist sagging or jumping due to gravity or the tension of cables held therein. The cable sleeve 10 can be bent in any shape as desired such as an arc of a circle, any angle between 0-360°—most commonly 45°, 90° or 180°—or coiled around an axis to offer a required length.

The cable sleeve 10 of the present invention preferably employs one or more shape-holding members 12.

The shape-holding member 12 should be of an appropriate thickness to support bending for turns while being rigid enough to hold shape and prevent the cables from sagging under gravity. In a preferred embodiment, the shape-holding member 12 is a wire having a thickness, in American Wire Gauge (AWG) units, of 8-24, preferably, 12-20.

In an embodiment of the present invention, the cable sleeve 10 may also employ an adhesive backing on a portion of its outer surface to enable the cable sleeve 10 to be affixed to a user-defined surface. The adhesive backing preferably is an adhesive glue or an adhesive foam tape. The adhesive backing preferably runs substantially from the first end to the second end of the flexible conduit either in a continuous strip or in segmented portions.

To accommodate the adhesive backing, in an embodiment of the present invention, the flexible conduit 11 preferably has a flattened surface upon which the adhesive backing is affixed such that a cross-section of the flexible conduit 11 resembles a “D”. In alternative embodiments, the cable sleeve 10 may employ on its outer surface a member of hook and loop fasteners or a magnetic couple, with the corresponding or cooperating member being affixed to a surface at a user-defined location.

In accordance with another embodiment of the present invention, the cable sleeve 10 employs loops on the outer surface of the flexible conduit 11. The loops can engage a hook or a nail that is secured against a wall or ceiling. Once hung, the loops are preferably fully hidden from view. Similarly, the cable sleeve 10 may employ reinforced openings along the length of the flexible conduit 11 for hanging the cable sleeve 10 from a hook or nail.

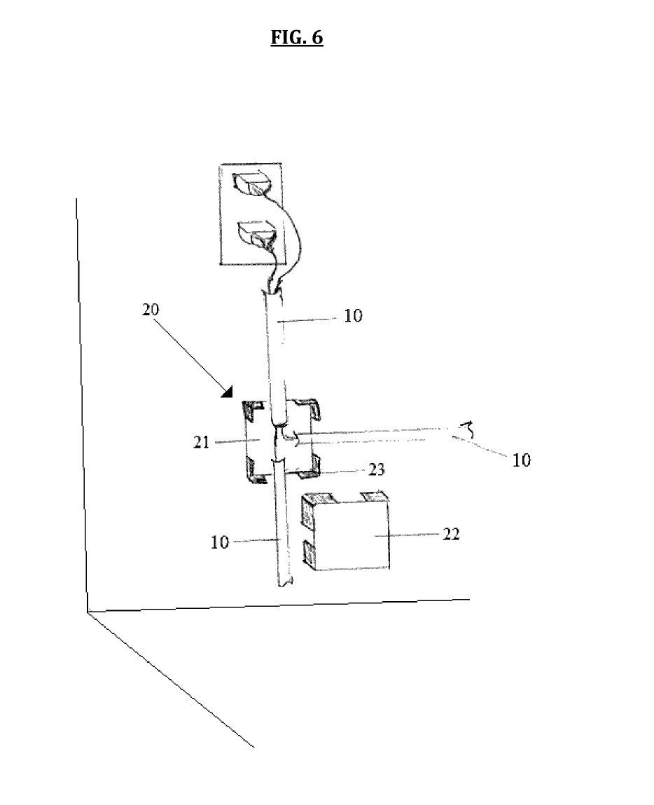

FIG. 6 illustrates a junction box 20 for optional use with one or more cable sleeves 10 of the present invention. The junction box 20 is preferably constructed of a rigid material such as metal, plastic or wood and is preferably composed of a base 21 and a lid 22. The base 21 of the junction box 20 employs notches, grooves, channels or hooks to take in and route out one or more cable sleeves 10 in a desired direction. However, in other embodiments of the present invention, notches, grooves, channels or hooks are not employed and the shape-holding properties of the cable sleeve 10 are relied upon to neatly route one or more cable sleeves 10 through the junction box 20. In one embodiment, the peripheral edges of the junction box 20 employ raised corners 23 on either the base 21, lid 22 or both to further direct the routing of cable sleeves 10. Once the cable sleeves 10 are arranged in the junction box 20, corresponding ridges and channels in the base 21 and lid 22 are fitted over one another and snapped into place.

The base 21 of the junction box 20 may employ one or more spikes, adhesive, clips, snaps, catches, magnets, hook and loop fasteners and the like so that it may be affixed to a floor, wall, ceiling or other supporting structure. The junction box 20 may also be provided with a hook or hanger so that it can be secured to a supporting surface using nails or screws.

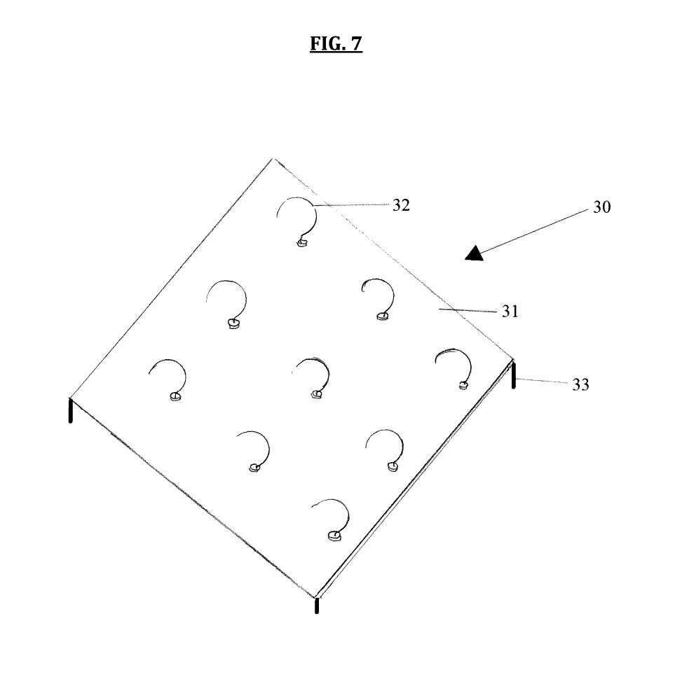

FIG. 7 illustrates the routing plate 30 of the present invention. The routing plate 30 provides a clean separation and detangling at the intersection of multiple cable sleeves 10. The routing plate 30 comprises a substrate 31 which may employ hooks 32 on either side. Multiple cable sleeves 10 may meet at the routing plate 30, and are secured to the hooks 32 on either side as desired using the loops or holes with reinforcement disposed on the cable sleeve 10 as described above or by running the cable sleeve 10 through the hooks 32. It should also be appreciated that notches, channels or grooves may be employed for routing the cable sleeves 10 instead of hooks 32. In one embodiment, the routing plate 30 may employ three or more legs 33 to enable it to stand against and slightly away from a flat surface to provide ample space for cable sleeves 10 to pass on both sides of the substrate 31.

In another embodiment, a free-standing support (not shown) may be employed that is comprised of a relatively heavy block made of a material such as metal, glass, plastic or wood with one or more hooks fastened to the heavy block. The free-standing support has a flat base similar to a cube or paperweight. The distance the hook extends from the surface of the heavy block may be adjustable by a user or fixed. The free-standing support may then be placed on any substantially flat surface and a cable sleeve 10 is routed using the one or more hooks.

The present invention is also directed to a method of routing a cable that employs the steps of inserting a cable into a flexible conduit via a slot running through the flexible conduit, connecting the cable to a wall outlet, electronic device or wall jack, and bending a portion of the flexible conduit into a self-retaining user-determined path.

The invention illustratively described herein suitably may be practiced in the absence of any element or elements, limitation or limitations, which is not specifically disclosed herein. Thus, for example, in each instance herein, any of the terms “comprising,” “consisting essentially of” and “consisting of” may be replaced with either of the other two terms. The terms and expressions that have been employed are used as terms of description and not of limitation, and there is no intention in the use of such terms and expressions of excluding any equivalents of the features shown and described or portions thereof, but it is recognized that various modifications are possible within the scope of the invention claimed. Thus, it should be understood that although the present invention has been specifically disclosed by preferred embodiments and optional features, modification and variation of the concepts herein disclosed may be resorted to by those skilled in the art, and that such modifications and variations are considered to be within the scope of this invention as defined by the appended claims. All patents and publications cited herein are hereby incorporated by reference.

1. A cable sleeve comprising:
a flexible conduit having a first end with an opening and a second end with an opening; and
a shape-holding members that extends along at least a portion of the flexible conduit;
wherein the flexible conduit has a slot that extends from the first end to the second end of the flexible conduit for receiving one or more cables.

2. The cable sleeve according to claim 1 wherein the sleeve further comprises one or more fasteners positioned adjacent the slot.

3. The cable sleeve according to claim 1 wherein the flexible conduit further comprises a pocket extending substantially from the first end to the second end of the flexible conduit, and wherein the shape-holding member is disposed within the pocket.

4. The cable sleeve according to claim 1 wherein the shape-holding member is woven into the flexible conduit.

5. The cable sleeve according to claim 1 wherein the shape-holding member is disposed within a wall of the flexible conduit.

6. The cable sleeve according to claim 1 wherein the shape-holding member extends substantially from the first end to the second end of the flexible conduit

7. A cable sleeve comprising:
a flexible conduit having a first end with an opening and a second end with an opening; and
a shape-holding member extending substantially from the first end to the second end of the flexible conduit;
wherein the flexible conduit has a slot that extends substantially from the first end to the second end of the flexible conduit.

8. A cable sleeve comprising:
a flexible conduit having a first end with an opening and a second end with an opening; and
a shape-holding member;
wherein the flexible conduit has a slot that extends substantially from the first end to the second end of the flexible conduit; and
wherein a cable comprising a conductive wire is removably disposed within the flexible conduit.

9. A junction box comprising one or more of the cable sleeves of claim 1.

10. A routing plate comprising one or more of the cable sleeves of claim 1.
